(19) United States
(12) Patent Application Publication
(10) Pub. No.: US 2021/0345557 A1
(43) Pub. Date: Nov. 11, 2021

(54) Vining Plant Support via Posts and Modular Braces

(71) Applicants: Anisha S Vyas, Woodstock, GA (US); Shabnam Satyarthi, Princeton, NJ (US); Parveen S Kapoor, Satellite Beach, FL (US); Jessie M Kapoor, Hilliard, OH (US)

(72) Inventors: Anisha S Vyas, Woodstock, GA (US); Shabnam Satyarthi, Princeton, NJ (US); Parveen S Kapoor, Satellite Beach, FL (US); Jessie M Kapoor, Hilliard, OH (US)

(21) Appl. No.: 17/381,132

(22) Filed: Jul. 20, 2021

Related U.S. Application Data
(63) Continuation-in-part of application No. 16/354,095, filed on Mar. 14, 2019.
(60) Provisional application No. 62/646,876, filed on Mar. 22, 2018.

(51) Int. Cl. A01G 9/12

(52) U.S. Cl. CPC A01G 9/122

(57) ABSTRACT

A plant support system that is anchored into the ground to provide stable support to a vining plant by use of a series of posts and braces. The post is installed into the ground. A brace-like attachment is then attached to the post at any location along the length of the post. The brace-like attachment can be installed on the post at any point during the growth of the vining plant. Additionally, there is a connection piece that can connect one post to another post in order to vertically or in another direction that is necessary, based on the needs of the specific vining plant, to extend the reach of the support system. This allows the full support system to grow indeterminately along with the vining plant. This support system supports the plant from a lower elevation to a higher elevation, in response to the growth of the plant.

### CROSS REFERENCE TO RELATED APPLICATION

This application claims priority to the utility patent Ser. No. 16/354,095 filed on Mar. 14, 2019 and also claims priority to the provisional patent No. 62/646,876 filed on Mar. 22, 2018.

### BACKGROUND

There are two types of vining plants, ones with tendrils that grow naturally from the plant and are meant to hold onto anything it can find to help support the plant to comfortably grow vertically, and ones without tendrils that naturally grow vertically until the weight of the plant becomes too much to bear and are then pulled down by the weight and forced to grow on the grounds surface. In the past, multiple methods have been used to support plants that are not capable of supporting themselves through the natural means of tendrils or similar mechanisms. The simplest method has been to attach tomato and similar vining plants to rods, sticks, posts or stakes (hereinafter, “the stake”) that are inserted into the ground by tying them with cloth or plastic zip ties. This method is less than ideal because the plant only receives the support for the predetermined length of the stake (no extension can be added). Additionally, the plant's support is entirely dependent on the security of the single stake in the ground. If the stake were to fall over from a weak grasp of the soil, then the entire plant risks being terminally damaged. Additionally, the use of the cloth or plastic zip ties to tie the vine to the stake may work well initially, but as the vine continues to grow, the lower older growth becomes thicker and can be cut or suffocated by the tie if not regularly monitored and adjusted.

One solution to this problem was the creation of the “tomato cage”. The cage consists of 3-4 vertical wires or rods that are inserted into the ground which are perpendicularly attached to the surface of the wire circles that increase in size the higher you go. This adds a moderately more stable grasp of the soil as there are more points of contact, but the stability of the design still heavily depends on wires inserted into soil or another ground substrate. If outside conditions are less than ideal, or the plant grows past the highest point of the cage, the cages have been known to fall over and cause terminal damage to the plant especially in windy conditions. An unrealized problem that the cage creates in contrast to tying to stakes, is that the cage only supports these plants through their outermost growth; most commonly the leaves that grow outward away from the main stalk. The cage forces the plant to extend its leaves as far out as it can to rest on the wire circles in order to hold up the weight of the entirety of the plant, essentially reassigning the role of tendril to the leaves. This is a very superficial method of support, and for a tomato plant, for example, this can cause a lot of stress on the plant and result in a less than optimal yield. Another problem the cage creates is that it compresses the entire plant into a limited space. This can result in an ideal environment for diseases and pests. This also makes it difficult to prune and pick the fruit as the entire plant is crowded within a limited space because it is being blocked and contained by the wire cage. Based on the foregoing, it is the general object of the present invention to provide adequate support to a vining plant that overcomes the drawbacks of the prior art.

### BRIEF SUMMARY OF THE INVENTION

It is the object of the present invention to provide a vertical plant support system that uses post(s) (hereinafter “the post(s)”), which can be hollow or solid taking the cross section or any geometric shape such as circular or rectangular and can be made from metal, plastic or natural materials such as wood, or a combination of different materials, that is anchored into the ground to provide a stable support for additional posts that are attached to it. A brace-like attachment(s) (hereinafter “the brace(s)”), which can be made from metal, fabric, plastic, or natural materials such as wood, or a combination of multiple materials, is then modularly attached to the posts at any time during the growth of the plant with the intention of providing necessary support needed for the growing vine. The brace(s) are removable and reattachable as required in the direction of the growth of the vining plant. The braces can have sharp corners such as square or rectangular or can have rounded corners such as circular or oval. The braces can also be a solid form, or made from a fabric which hangs down until used and attached properly to the post. The braces can be one piece, or multiple pieces attached together to hold the vining plant within a close proximity to the post in order to support the growth of the vining plant. There are extension connection piece(s) (hereinafter “the connection piece(s)”) which can be made from metal, plastic or a natural material such as wood, or a combination of different materials, that attach to the posts which allow the vertical support system to grow with the plant or vine in the direction that the plant or vine would require such as vertically, in an arch, horizontally after being lifted off the ground, or down back to the ground after growing upward. The connection pieces can be hollow rectangular, hollow circular, L shaped, U shaped, or completely solid in any shape which will allow the connection piece to connect the 2 posts together. The connection piece can also have bends as needed to help designate the direction of the next post. This system supports the plant from the ground up to a higher elevation—as far as is required, and in any direction that is required, such as vertically, horizontally, in an arch or down back to the ground after growing upward, in specific increments (dependent on the length of the post), in response to the growth of the plant.

### BRIEF DESCRIPTION OF THE DRAWINGS

FIG. 1. Shows example “Extended Configuration” of invention

FIG. 2. Shows example “Basic Configuration” of invention

FIG. 3. Shows unlabeled “Extended Configuration” of invention

FIG. 4. Shows zoomed in example detail of “Connection Piece”

FIG. 5. Illustrates invention in use with plant

### DETAILED DESCRIPTION OF THE DRAWINGS

FIG. 1. FIG. 1 shows the “Vining Plant Support Via Connecting Posts and Modular Braces” in its example “extended” configuration with two posts connected by one “Connection Piece” and an example of how braces can connect to the posts. The labels correspond with the different parts explained herewith: “1”—Post, “2”-Braces, “3”—Connection Piece

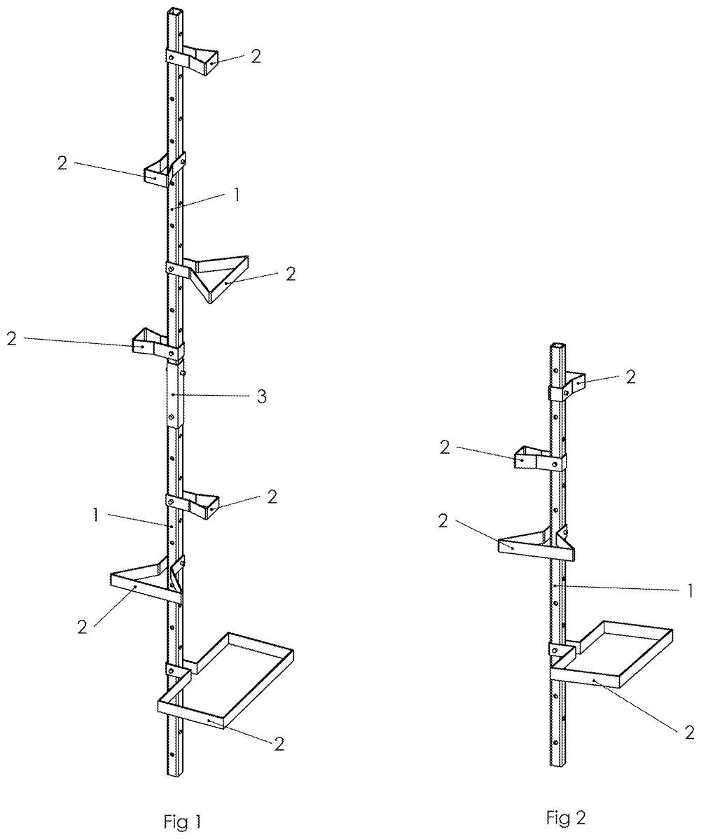

FIG. 2. FIG. 2 shows the “basic” configuration of the “Vining Plant Support Via Connecting Posts and Modular Braces” using one post. All the number callouts have the same correlations as described in FIG. 1.

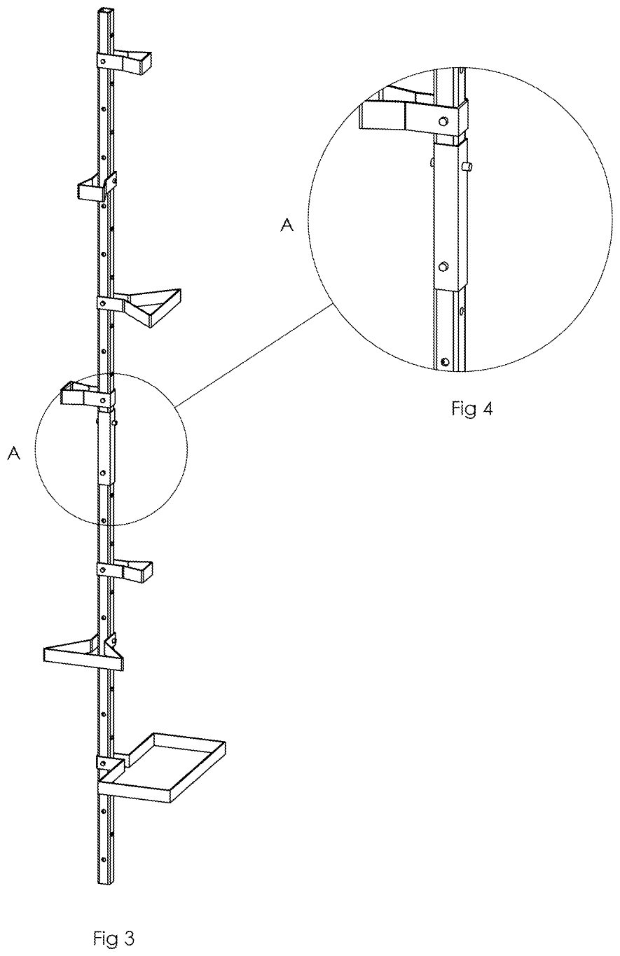

FIG. 3. FIG. 3 presents a cleaner view of the “extended” configuration of the “Vining Plant Support Via Connecting Posts and Modular Braces”.

FIG. 4. FIG. 4 illustrates a zoomed-in detail example of how the connection piece fastens to the lower and upper posts subsequently connecting both posts.

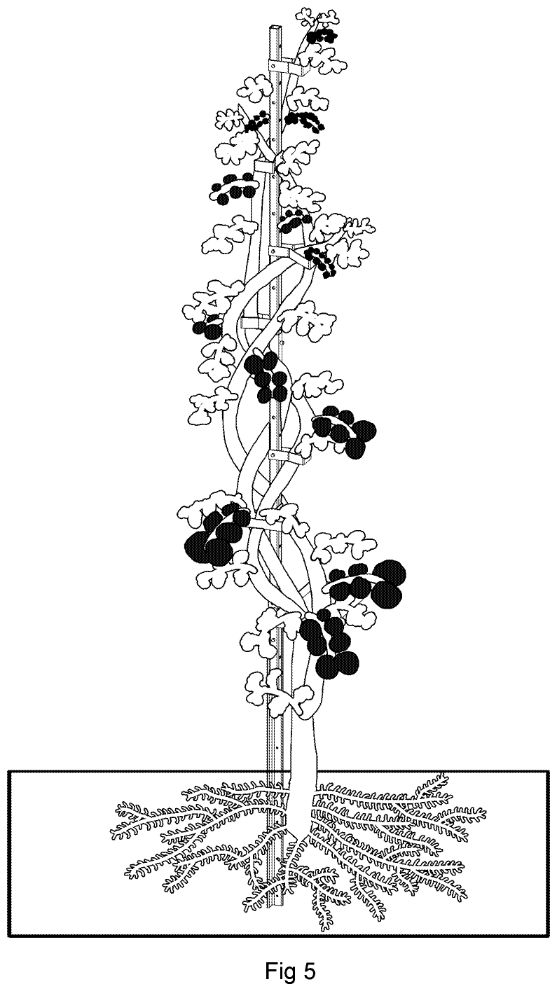

FIG. 5. FIG. 5 illustrates a possible configuration of the invention interacting with an actual vining tomato plant.

### DETAILED DESCRIPTION AND BEST MODE OF IMPLEMENTATION

The present invention provides an apparatus for supporting plant life growing in a ground area which includes a post, which can be hollow or solid taking the cross section or any geometric shape such as circular or rectangular and can be made from metal, plastic or natural materials such as wood, or a combination of different materials, and exists in predetermined lengths. Additional posts can be attached to existing installed posts by using the connection piece which holds the posts together.

The connection piece which can be made from metal, plastic or a natural material such as wood, or a combination of different materials, that attach to the posts which allow the support system to grow with the plant or vine in the direction that the plant or vine would require such as vertically, in an arch, horizontally after being lifted off the ground, or down back to the ground after growing upward. The connection pieces can be hollow rectangular, hollow circular, L shaped, U shaped, or completely solid in any shape which will allow the connection piece to connect the 2 posts together. The connection piece can also have bends as needed to help designate the direction of the next post.

Once the post assembly has been installed into the ground, there will be a variety of braces included to support the vine. The braces can be made from metal, fabric, plastic, or natural materials such as wood, or a combination of multiple materials. The braces can have sharp corners such as square or rectangular or can have rounded corners such as circular or oval. The braces can be one piece, or multiple pieces attached together to hold the vining plant within a close proximity to the post in order to support the growth of the vining plant. Depending on the needs of the vining plant, the user will determine which brace is most appropriate to support the vine. Each brace is intended to be installed directly onto the post by the user and placed around the plant and then connected to the post without causing any damage to the plant itself.

As the plant grows, more braces can be attached to support the vine in its growth off of the ground. One of the greatest advantages of our present invention is that the braces can also be removed, rearranged and reattached. When the fruit at the bottom of the plant has already been harvested and the vine no longer needs as much support at that location, the brace can be removed from its original placement on the post and then moved and attached to an alternate location on the post where the plant is flowering or fruiting in order to provide additional support where it is needed.

It is the object of the present invention to be a modular assembly that can be easily adjusted to both the growing plant and in adaptability to various kinds of vining plants. Where the braces can be mounted at any location along the length of the post.

It is the object of the present invention to take up minimal garden space and to allow the plant to focus its growth off of the ground. This will allow the user to better see the plant and properly harvest the fruit off the plant without being obstructed by any other factors on the ground.

It is the object of the present invention to “grow” with the growing plant as more attachments can be added and it can extend above the ground in any direction in predetermined increments based on the length of the post.

It is the object of the present invention to provide an apparatus for supporting plant life growing in a ground area wherein all parts are made of a durable material, such as metal, plastic or a natural material such a wood, to minimize rusting or other deterioration thereof.

It is the object of the present invention to provide an apparatus for supporting plant life growth in a ground area wherein a single apparatus can be used for supporting multiple different types of vining plant life such as, but not limited to, tomato, grapes, cucumber, and melon plants.

It is the object of the present invention to be an apparatus that is capable of and expected to be re-used year after year.

It is the object of the present invention to minimize any damage that the growing plant can incur due to pests, diseases, natural elements, and lack of support whilst using this apparatus.

This system supports the plant from the ground to a higher elevation as far as is required in predetermined increments (depending on the length of the post), in response to the growth of the plant.

It is the object of the present invention to focus support on the main vine, also known as the stalk, of the plant. This will ensure proper and healthy growth by reducing stress to the plant which in turn increases yield and reduces impacts from pests & disease.

It is the object of the present invention to assist the user in effectively pruning, maintaining and monitoring the health of the vining plant.

It is the object of the present invention to support both determinate and indeterminate vining plants.

1. The apparatus for vertically supporting the vine of a plant to grow substantially perpendicularly from the ground comprising:
A. one or more posts;
i. that install substantially perpendicular to the ground;
ii. or attach to the one or more posts;
B. a plurality of connection pieces that allow a user to securely connect the one or more posts above the lower one or more posts extending the reach of the entire support system substantially perpendicular to the ground; and
C. a plurality of braces that attach to the one or more posts to support the vining plant throughout the lifecycle of the vining plant.

2. The apparatus for vertically supporting the vine of the plant to grow substantially perpendicularly from the ground as in claim 1 that can increase in length in predetermined increments dependent on the length of the one or more posts in order to match the length of the growing vining plant via the plurality of connection pieces.

3. The apparatus for vertically supporting the vine of the plant to grow substantially perpendicularly from the ground as in claim 1 wherein the said plurality of braces are adjustable in regards to location of attachment to the one or more posts and can be modularly removed and reattached at a new location on the one or more posts based on the growth of the vine.
